(19) United States
(12) Patent Application Publication
(10) Pub. No.: US 2023/0252701 A1
(43) Pub. Date: Aug. 10, 2023

(54) METHOD FOR GENERATING MULTI-DEPTH IMAGE

(71) Applicant: PJ FACTORY CO., LTD., Seoul (KR)

(72) Inventor: Jung Hwan PARK, Seoul (KR)

(73) Assignee: PJ FACTORY CO., LTD., Seoul (KR)

(21) Appl. No.: 18/008,072

(22) PCT Filed: Jun. 3, 2021
(86) PCT No.: PCT/KR2021/006907

§ 371 Date: Apr. 7, 2023

(30) Foreign Application Priority Data
Jun. 3, 2020 (KR) 10-2020-0066896
Dec. 22, 2020 (KR) 10-2020-0180958

(51) Int. Cl. G06T 11/60

(52) U.S. Cl. CPC G06T 11/60; G06T 2200/24

(57) ABSTRACT

A method of generating a multi-depth image is disclosed. According to at least one embodiment, the present disclosure provides a method of generating a multi-depth image capable of smooth transition between images, including, in response to user input, determining an image group including a plurality of images, generating multi-depth images for each of one or more subject images included in the image group according to a user input for inserting in each of the one or more subject images, one or more other images, and setting the subject images from which the multi-depth images are generated, to stop positions respectively, in which the images in the image group are stopped from being reproduced during reproduction.

### TECHNICAL FIELD

The present disclosure relates to a method of generating a multi-depth image of a tree structure capable of a smooth transition and a method of viewing the generated multi-depth image.

### BACKGROUND ART

The statements in this section merely provide background information related to the present disclosure and do not necessarily constitute prior art.

With the development of information communications and semiconductor technologies, users can take advantage of the Internet to access or store and use various contents in their electronic devices, e.g., smartphones or PCs.

Across the quantitatively vast but widely dispersed random content collections, highly related content items are hard to search for and identify all at once.

As an example, when an image file is opened with an electronic device, detailed information on a specific part of the image file or an enlarged image of the part may be requested. For example, a vehicle image may need to be viewed along with a more detailed image of a specific part, such as a headlight or a wheel. This typically requires a search for new relevant images, which is a hassle for the user.

To solve this issue, the present applicant has registered, as Korean Patent No. 10-1501028 (registered on Mar. 4, 2015), the invention that relates to an image of a new format (hereinafter referred to as ‘multi-depth image’) wherein a basic image (hereinafter, referred to as ‘main image’) allows the insertion of another image (hereinafter referred to as ‘insert image’) therein to provide additional information, and a generation method thereof.

The document discloses a user interface for defining a multi-depth image and generating and editing a multi-depth image. The present disclosure is a follow-up to the issued patent and provides a method of generating a multi-depth image in various ways according to improved properties of images or objects and the relationship between the objects, and providing a more intuitive way for users to view each of the images in a multi-depth image.

### SUMMARY

The present disclosure in some embodiments seeks to provide a method for users to more intuitively generate a multi-depth image capable of a smooth transition and to view each of the images in the multi-depth image.

According to at least one aspect, the present disclosure provides a method of generating a multi-depth image capable of smooth transition between images, including in response to user input, determining an image group including a plurality of images, generating multi-depth images for each of one or more subject images included in the image group according to a user input for inserting in each of the one or more subject images, one or more other images, and setting the subject images from which the multi-depth images are generated, to stop positions respectively, in which the images in the image group are stopped from being reproduced during reproduction.

As described above, the present disclosure according to at least one embodiment can more intuitively and conveniently generate a multi-depth image capable of smooth transition.

According to another embodiment of the present disclosure, the stop positions and transition images in a multi-depth image may be changed or edited more easily.

### BRIEF DESCRIPTION OF DRAWINGS

FIG. 1 illustrates a tree structure of a multi-depth image.

FIG. 2 illustrates a case of inserting an image in a first mode.

FIG. 3 illustrates a case of inserting an image in a second mode.

FIG. 4 is a block diagram of a configuration of an electronic device for implementing at least one embodiment of the present disclosure.

FIG. 5 is a flowchart illustrating the operation of the electronic device.

FIG. 6 is a diagram illustrating the generation of a multi-depth image by user manipulation.

FIG. 7 is a diagram illustrating a transition between objects in a multi-depth image.

FIG. 8 is a diagram illustrating another transition between objects in a multi-depth image.

FIG. 9 is a flowchart illustrating an example of a method of generating a multi-depth image capable of a smooth transition.

FIG. 10 is a diagram illustrating an example of a method of generating a multi-depth image capable of a smooth transition.

FIG. 11 is a flowchart illustrating another example of a method of generating a multi-depth image capable of a smooth transition.

FIG. 12 is a diagram illustrating another example of a method of generating a multi-depth image capable of a smooth transition.

FIGS. 13A and 13B are flowcharts illustrating yet another example of a method of generating a multi-depth image capable of a smooth transition.

FIG. 14 is a diagram illustrating yet another example of a method of generating a multi-depth image capable of a smooth transition.

FIG. 15 is a flowchart illustrating yet another example of a method of generating a multi-depth image capable of a smooth transition.

FIG. 16 illustrates a user interface for implementing an extended application of the present disclosure.

### DETAILED DESCRIPTION

Hereinafter, some embodiments of the present disclosure will be described in detail with reference to the accompanying drawings. In the following description, like reference numerals designate like elements, although the elements are shown in different drawings. Furthermore, in the following description of some embodiments, a detailed description of known functions and configurations incorporated therein will be omitted for the purpose of clarity and for brevity.

Additionally, various ordinal numbers or alpha codes such as first, second, A, B, (a), (b), etc., are prefixed solely to differentiate one component from the other but not to imply or suggest the substances, order, or sequence of the components. Throughout this specification, when a part “includes” or “comprises” a component, the part is meant to further include other components, not excluding thereof unless specifically stated to the contrary. The terms such as “unit,” “module,” and the like refer to units for processing at least one function or operation, which may be implemented by hardware, software, or a combination thereof.

Hereinafter, some embodiments of the present disclosure will be detailed with reference to the accompanying drawings.

A multi-depth image refers to an image in which a plurality of images is formed in a tree structure by hierarchically repeating the process of inserting another image into one image. A multi-depth image may be composed of one main image and a plurality of sub-images. A plurality of images of a multi-depth image may be hierarchized considering a specific subject or context, and then configure nodes to form a single tree structure. In this case, the main image forms a root node of the tree structure, and the sub-images form lower nodes.

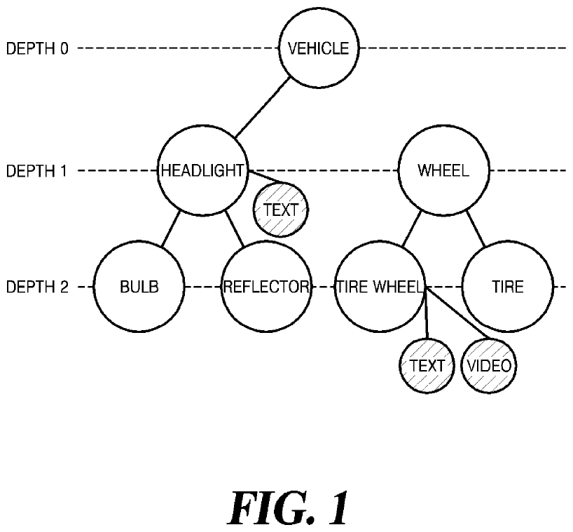

FIG. 1 shows an exemplary tree structure of a vehicle-themed multi-depth image.

The main image representing the vehicle's overall appearance corresponds to the root node (depth 0). Images of a headlight and a wheel, which are components of the vehicle, are inserted as sub-images into the main image to form nodes of depth 1. The images of a bulb and a reflector, which are components of the headlight, are inserted as sub-images into the headlight image to form nodes of depth 2. In addition, images of a tire and a tire wheel, which are components of the wheel, are inserted as sub-images into the wheel image to form nodes of depth 2.

As a result, the vehicle node has descendants of the headlight node and the wheel node, the headlight node has descendants of the bulb node and the reflector node, and the wheel node has descendants of the tire node and the tire wheel node. Then, in this way, in the present embodiment, a plurality of sub-images are interconnected in a tree structure, so that the images of the child nodes are inserted into the image of the parent node.

The multi-depth image is an image format in which an object of one or more child nodes are inserted into an object of a parent node in a tree structure as illustrated in FIG. 1. This means that multiple images connected in a tree structure form a single image file. When an object of a child node is inserted into an object of a parent node, the inserted object is generally an image that may be two-dimensional or three-dimensional. However, in addition to the image, various objects may be available such as video, text, audio, links to other files, Internet address links, bookmarks, 360 images, and 3D objects to be inserted into the object of the parent node as the object of the child node. Hereinafter, the present embodiment will be described on the premise that the objects inserted into each node of the multi-depth image are images. However, it should be noted that this is for the convenience of description and does not limit the present disclosure.

Moreover, in the tree structure of the multi-depth image, multimedia content may be additionally mapped to each node. Here, the multimedia content is digital content related to an image inserted in each node and may include various types of objects such as text, video, and audio. For example, in the tree structure of FIG. 1, text indicating specification information such as manufacturer, luminance, and lifetime may be mapped to a headlight node. Text representing specification information such as material and manufacturing method may be mapped to the tire wheel node. In addition, video indicating the shape of the tire wheel during vehicle driving may be additionally mapped to the tire wheel node.

The present disclosure includes two modes as a method of generating a multi-depth image.

The first mode is a mode in which a child node image is inserted at a specific position in the parent node image. In the first mode, attribute information including a node attribute indicating the connection relationship between the parent node image and the child node image, and a coordinate attribute indicating the position where the child node image is inserted in the parent node image is defined. The attribute information is stored together with the image of the parent node and the image of the child node.

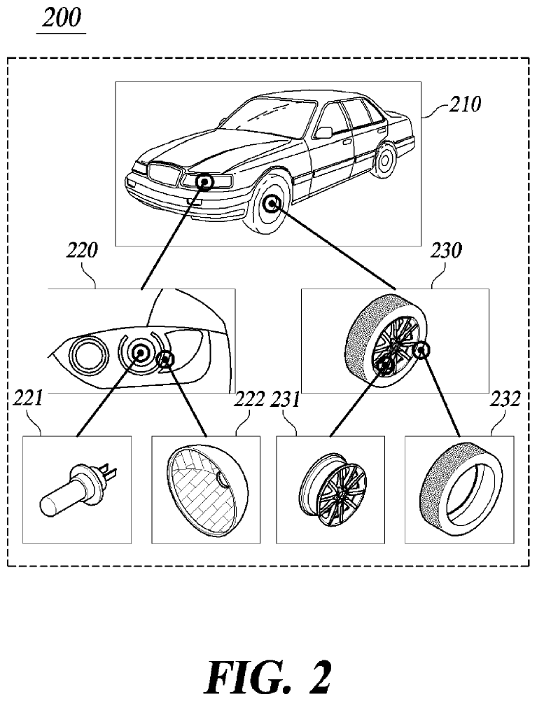

FIG. 2 illustrates an example of inserting an image in a first mode. Referring to FIG. 2, the multi-depth image 200 for the vehicle may include an entire vehicle image 210, a headlight image 220, a bulb image 221, a reflector image 222, a wheel image 230, a tire wheel image, and a tire image 232.

The user may insert the headlight image 220 (a detailed image of the headlight) at the position of the headlight in the vehicle image 210 displayed on the display unit of the electronic device. For example, the user may select the headlight image 220 by touching or clicking, and drag the selected headlight image 220 to the position to be inserted in the vehicle image 210 to insert the headlight image at the corresponding position.

When the headlight image is inserted, a first marker (e.g., ‘⊙’ in FIG. 2) is displayed on the vehicle image 210 to indicate that another image is inserted at the position of the headlight. The user may select the first marker ⊙ displayed on the vehicle image 210 and view the headlight image 220 inserted at the position through the display unit of the electronic device.

Meanwhile, while the headlight image 220 is displayed on the display unit, the user may insert the detail image 221 of the bulb at the bulb position of the headlight image 220. A first marker ‘⊙’ for indicating that the image is inserted is displayed in the headlight image 220 at the position where the bulb image 221 is inserted.

In this way, the electronic device may generate a multi-depth image in the form of a tree structure by inserting a child node image at a specific position of the parent node image according to a user's manipulation, and display the image of the child node inserted at the position marked with the marker when an input of clicking or touching a marker ⊙ displayed in the parent node image is received.

The first mode described above is useful when defining an insertion relationship between two images in a dependency relationship, such as a vehicle and a headlight, or two images in a relationship between a higher-level concept and a lower-level concept. However, this dependency relationship may not be established between the two images. For example, for two images that are related by an equal relationship rather than a dependency relationship, such as photos showing changes over time, before/after comparison photos, and inside/outside comparison photos, it is not natural to insert one image at a specific position in another image.

For example, if the headlight image 220 in FIG. 2 is a photo with the headlight off, the user may try to further associate the photo with the headlights on with the photo with the headlights off. It is unnatural to insert a photo with the headlight on at a specific position in the image with the headlight off.

The second mode, which is another mode described in the present disclosure, is a mode in which a child node image is inserted into a parent node image without designating a specific position in the parent node image. That is, the child node image is inserted into the parent node image in the same relationship as the parent node image. In the second mode, only a node attribute indicating a connection relationship between a parent node image and a child node image is defined, and a coordinate attribute indicating a position where the child node image is inserted in the parent node image is not defined. Node attributes are stored together with the image of the parent node and the image of the child node.

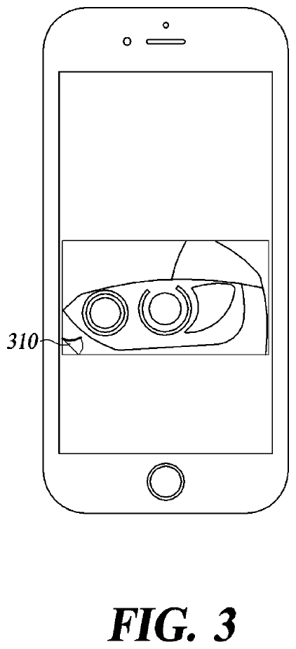

A second marker indicating that the object has been inserted in the second mode is displayed on the image of the parent node. The second marker may be displayed on the edge of the first object so as not to interfere with inserting the object in the first mode at a specific position in the parent node image. For example, as shown in FIG. 3, the second marker may be a marker 310 that a page is folded at one edge of the parent node image.

The method of configuring a multi-depth image using the first mode and the second mode described above may be implemented as a program and executed by an electronic device capable of reading the program.

The electronic device executes the program and inserts an image in the first mode in some nodes and the image in the second mode in other nodes to generate a multi-depth image in a tree structure. Alternatively, the electronic device may insert a plurality of images into one image corresponding to one node by using the first mode and the second mode.

A plurality of images hierarchically inserted in at least one or more of the first mode or the second mode is generated as a single file together with attribute information defining a relationship between the images so that a multi-depth image consisting of a tree structure is generated.

Attribute information defining between a parent node and a child node associated in the first mode includes a node attribute defining a parent node and a child node, and a coordinate attribute indicating a specific position in the parent node image. On the other hand, attribute information defining between a parent node and a child node associated in the second mode includes only the node attribute without the coordinate attribute.

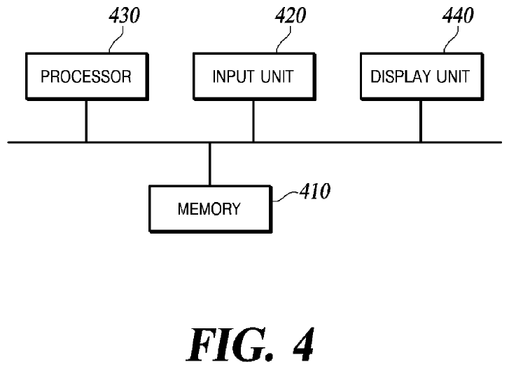

FIG. 4 is an exemplary diagram of an electronic device for implementing the technology of the present disclosure. The electronic device may include a memory 410, an input unit 420, a processor 430, and a display unit 440.

The memory 410 stores a program for generating or viewing a multi-depth image in a first mode and a second mode. The input unit 420 may be a keypad, a mouse, or the like as a means for receiving a user's input, or may be a touch screen integrated with the display unit 440. The processor 430 receives user input from the input unit 420 and reads the execution codes of the program stored in the memory 410 to execute a function of generating or viewing a multi-depth image. The display unit 440 displays the execution result by the processor 430 so that the user may check it. Alternatively, when the input unit 430 is implemented as a touch screen, the display unit 440 may display a soft button for making a user input.

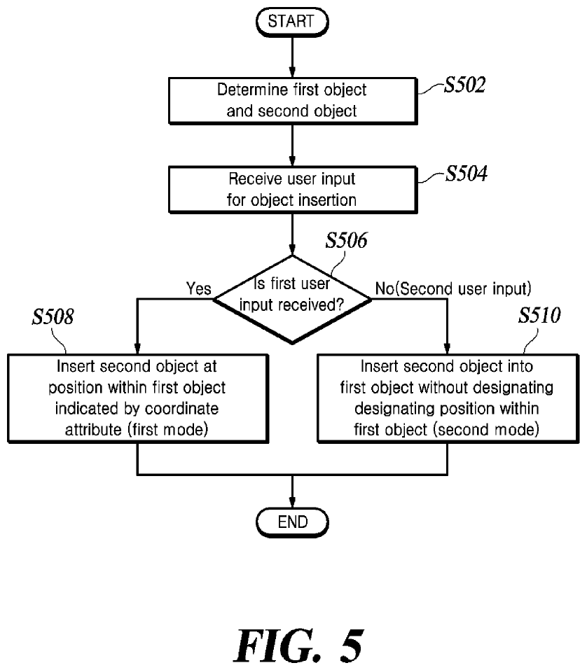

With reference to FIG. 5, the operation of the processor will be described when the above program is executed.

The processor 430 determines a first object corresponding to a parent node and a second object corresponding to a child node according to a user manipulation input through the input unit 420 (S502). Here, the first object is a two-dimensional or three-dimensional image having coordinate information. The second object may be an image or multimedia data such as audio or video.

The user may select the first object and the second object respectively corresponding to the parent node and the child node, by using images stored in the memory 410 of the electronic device or photos taken with a camera provided in the electronic device. As an example, a user may stack objects in layers by manipulating the input unit 420. The processor 430 may determine an object of a higher layer as a child node and an object of a layer immediately below the higher layer as a parent node. The lowest layer may be used as the main image corresponding to the root node.

When the processor 430 receives a user command (user input) for inserting the second object in the first object (S504), it determines whether the user input is a first user input or a second user input (S506). The first user input includes a node attribute connecting the first object and the second object and a coordinate attribute indicating the position of the second object in the first object. The second user input includes a node attribute without a coordinate attribute (S506).

If the received input is the first user input, the processor 430 executes the first mode (S508). That is, the second object is inserted at the position indicated by the coordinate attribute within the first object. The first user input is generated from user manipulation of assigning a specific position within the first object. For example, when a user drags the second object and assigns the second object at a specific position within the first object displayed on the display unit 440, the processor 430 inserts the second object at the specific position within the first object.

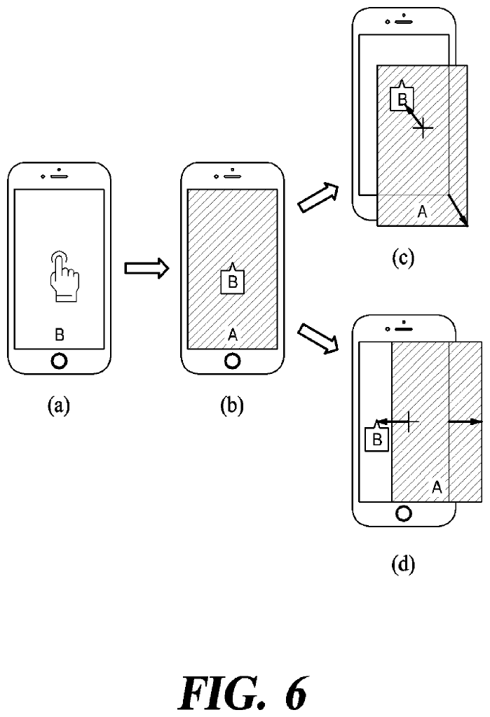

It is described in more detail with reference to FIG. 6. After the first object A and the second object B are selected by the user, in a state in which the second object B is displayed on the screen, when the user presses the second object B for more than a certain period of time ((a) of FIG. 6), the second object B becomes a pointer or an icon and the first object A is displayed on the screen ((b) of FIG. 6).

The user may select a position to insert the second object B while moving the second object B which becomes the pointer on the first object A. According to user manipulation of moving the second object B, the processor 430 moves the first object A in a direction opposite to the moving direction of the second object B. Referring to (c) of FIG. 6, in response to the manipulation of the user moving the second object B in the upper left direction, the processor 430 moves the first object A in the lower right direction. This allows rapid movement of the second object B on the first object A. In addition, this makes it possible to position the second object B on the edge of the first object A, and accordingly, it is easy to insert the second object B near or at the edge of the first object A.

When the user assigns the second object B to the specific position in the first object A, the processor 430 inserts the second object B at the specific position ((b) of FIG. 6). When the second object is inserted at the specific position of the first object by the first mode, the processor 430 stores in the memory 410 a node attribute defining a node connection relationship between the first object and the second object and a coordinate attribute indicating the specific position within the first object, together with the first object and the second object. To allow the user to identify that another object is inserted, a first marker (e.g., ‘⊙’ in FIG. 2) is displayed at the position where the second object is inserted in the first object. When the user selects the first marker on the first object displayed on the display unit 440, the processor 430 displays the second object inserted at the position of the first marker on the display unit 440.

Meanwhile, if the received input is the second user input, the processor 430 executes the second mode (S510). That is, the second object is inserted into the first object without designating a position within the first object. The second user input is generated from a user manipulation that does not assign a position within the first object. For example, the second user input may be generated from user manipulation of allocating the second object to an external area of the first object displayed on the display unit 440. Referring to FIG. 6, a user drags the second object B to position the second object in an external area of the first object (FIG. 6 at (d)). When the second object is allocated to the external area of the first object, the processor 430 generates the second user input and accordingly inserts the second object into the first object in the second mode without designating a specific position in the first object according to the second user input.

Alternatively, the second user input may be generated through manipulation of pressing a button assigned to the second mode as a physical button provided in the electronic device. Alternatively, the second user input may be generated by user manipulation of selecting a soft button or area displayed on the display unit 440 of the electronic device. The soft button or area may be displayed outside the first object or inside the first object. When the soft button or area is implemented to be displayed inside the first object, user manipulation of selecting the soft button or area should not allocate the coordinate attribute of the first object.

The node attribute included in the second user input is stored in the memory 410 together with the first object and the second object. A second marker (e.g., 310 of FIG. 3) indicating that the second object is inserted in the second mode may be displayed on one edge of the first object. When the user selects the second marker on the first object displayed on the display unit 440, the processor 430 displays the second object on the display unit 440.

A plurality of second objects to be inserted into the first object in the second mode may be selected. For example, if a user makes a second user input for collectively inserting the selected second objects into the first object in a second mode after selecting the plurality of second objects in the order of object A, object B, object C, and object D, the processor 430 sequentially and hierarchically inserts the second objects in the second mode. Here, the sequential/hierarchical insertion in the second mode means that each object is inserted into the immediately preceding object in the second mode in the order of the first object, object A, object B, object C, and object D. That is, object A among the second objects is inserted into the first object in the second mode, B object among the second objects is inserted into object A in the second mode, and object C is inserted into object B in the second mode. And, object D is inserted into object C in the second mode.

Meanwhile, the program stored in the memory 410 includes a user-intuitive function for displaying the second object inserted in the first object in the second mode to the user. As described above, the second mode is particularly useful in the case of association between photos representing changes over time, before/after comparison photos, and internal/external comparison photos. Accordingly, the present embodiment provides a viewing function in which the first object and the second object can be viewed while comparing each other.

Any one of the first object and the second object related in the second mode is displayed on the display unit 440. When the user inputs a gesture with directionality in this state, the processor 440 displays the first object and the second object with a transition between them according to the direction and movement length of the input gesture. The transition between the first object and the second object is gradually performed according to the movement length of the gesture. In other words, the degree of transition between the first object and the second object is different according to the movement length of the gesture.

There may be various methods of inputting a gesture having directionality. When a gesture of moving a touch from left to right is input while the first object is displayed, the first object displayed on the display unit 440 gradually transitions to the second object. When a gesture of moving a touch from right to left is input while the second object is displayed, the second object displayed on the display unit 440 gradually transitions to the first object. Alternatively, a gesture having directionality may be input in proportion to the time or number of times the soft button or the physical button of the electronic device is pressed. For example, the direction of the gesture may be determined according to the type of the direction key, and the movement length of the gesture may be determined according to the time during which the direction key is continuously pressed. When the user presses the “→” arrow key while the first object is displayed, the first object displayed on the display unit 440 may gradually transition to the second object in proportion to the time during which the “→” direction key is continuously pressed.

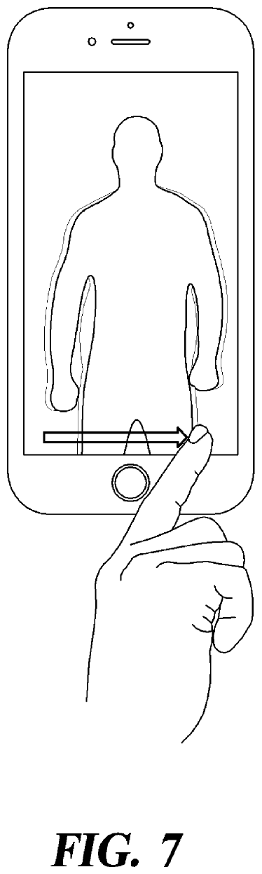

The degree of transition may be transparency. Referring to FIG. 7, the processor 430 may gradually adjust the transparency of the first object and the second object according to the movement length of the gesture and display the first object and the second object on the display unit 440 by overlapping the first object and the second object. When the gesture input is stopped (for example, touch release), an object having low transparency is selected from among the first object and the second object overlapped and displayed on the display unit 440. Alternatively, the first object and the second object may be displayed by overlapping each other with transparency at the time point when the gesture is stopped.

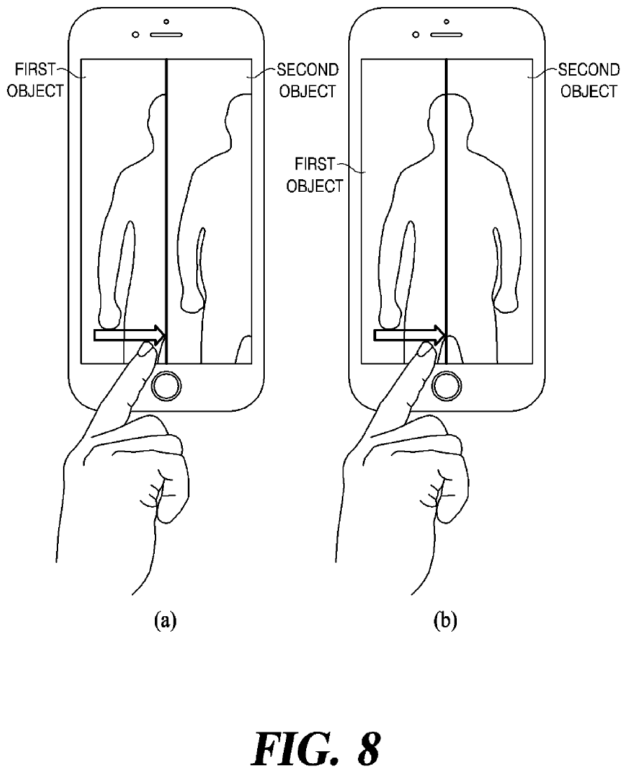

As another example, the degree of transition may be a ratio in which the second object is displayed on the screen of the display unit 440 relative to the first object. When a gesture is inputted while the first object is displayed, a partial area of the first object disappears from the screen by a ratio proportional to the movement length of the gesture. In addition, a partial area of the second object corresponding to the ratio is displayed in the area on the screen where the first object has disappeared. For example, referring to (a) of FIG. 8, when the touch is dragged from left to right, the first object is gradually pushed to the right according to the dragging length, and the second object gradually appears in the area of the screen where the first object is pushed. Alternatively, as shown in (b) of FIG. 8, the left part of the first object is folded by a ratio proportional to the length of dragging the touch from left to right, and a partial area to the left of the second object corresponding to the ratio may appear in the area of the screen where the first object is folded.

As an application of the present embodiment, an image group including a plurality of images may be inserted into the first object as a second object. The aforementioned example of selecting a plurality of second objects and inserting the plurality of second objects into the first object in a second mode sequentially/hierarchically is a case where the selected objects are respectively recognized as separated objects. That is, the example is to insert the plurality of objects into the first object in the second mode at once. On the other hand, in the application of this embodiment described herein, the image group including the plurality of images is treated as a single object. This corresponds to a group of images taken at regular time intervals, such as photos or videos taken in continuous mode. Also, a case where a user selects a plurality of images and then combines them into a single image group and sets them as a single object also corresponds to the application of the present embodiment.

When the second object is an image group including the plurality of images, as an example, the second object may be inserted into the first object in the first mode. If the first user input is entered in a manner that the user selects a second object and assigns the selected second object to a specific position within the first object displayed on the display unit 440, the processor 430 inserts one image (e.g., the first image) among a plurality of images included in the second object into a specific position of the first object. Then, the remaining images of the plurality of images are inserted into one image (the first image) in the second mode.

Since the second object is inserted at the specific position of the first object, the first marker (e.g., ‘⊙’ in FIG. 2) is displayed at the specific position of the first object. When the user selects the first marker, the processor 430 displays the first image of the second object inserted at the specific position of the first object on the display unit 440. Since the remaining images among the plurality of images are inserted into the first image displayed on the display unit 440 in the second mode, the second marker (e.g., 310 in FIG. 2) is displayed on one edge of the first image. When the user selects the second marker, the processor 430 plays the plurality of images. That is, the processor 430 plays the plurality of images by sequentially displaying the remaining images among the plurality of images on the display unit 440.

As another example, a second object, which is an image group including the plurality of images, may be inserted into the first object in the second mode. The user enters the second user input for inserting the second object into the first object in the second mode. For example, as described above, the second user input may be made through a method in which the user allocates the second object to an external area of the first object. The processor 430 inserts the second object into the first object without designating a specific position within the first object.

Since the second object is inserted into the first object in the second mode, the second marker is displayed on one edge of the first object. When the user selects the second marker, the processor 430 sequentially displays the plurality of images included in the second object on the display unit 440.

Meanwhile, the user may play the second object inserted in the first mode or the second mode in the first object through a gesture input having directionality. In a state where any one of the plurality of images included in the second object is displayed on the display unit 440 when receiving a gesture with directionality from the user, the processor 430 sequentially plays the images in the forward or reverse direction from the currently displayed image according to the direction of the gesture. The speed of play is determined by the speed of the gesture. When the gesture is stopped, the processor 430 displays, on the display unit 440, an image displayed at the time point of stopping the gesture from among the plurality of images. The user may insert another object in the first mode or the second mode in the image displayed at the time point of stopping the gesture. That is, the second object play method through gesture input provides a function of selecting an arbitrary image from among the plurality of images grouped into one image group and inserting another object into the selected image in the first mode or the second mode.

As an extended application, the present disclosure provides a method of reproducing intermediate-stage images (hereinafter referred to as ‘transition images’) during the transition from a first object to a second object. For example, the extended application described below allows transition images to be reproduced while one image (node) transitions to another image (node) in multi-depth images of a tree structure.

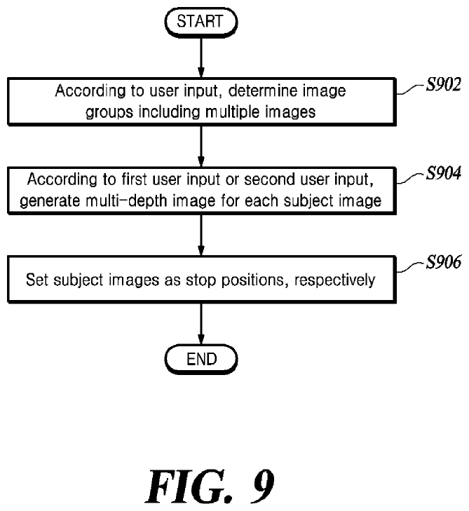

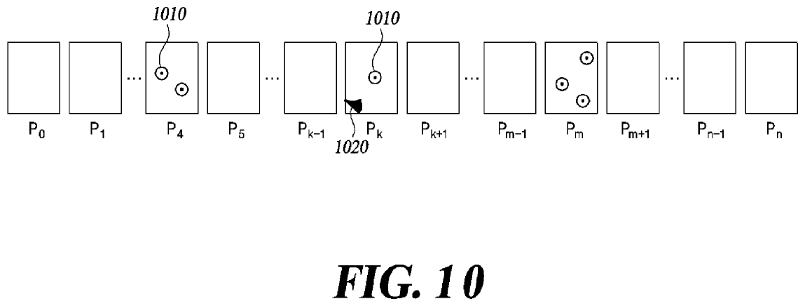

Referring to FIGS. 9 and 10, in response to user input, the processor 430 sets or determines an image group composed of or including a plurality of images P₀ to Pₙ (S902).

The image group may be pictures taken in a burst mode or may be a group of a plurality of images selected by a user. Alternatively, the image group may be a video. Notwithstanding, using an image group generated by grouping pictures taken in a burst mode or grouping still images may be easier than using a video when editing such as adding or deleting images or changing a stop position. Images in the image group are set to be reproduced sequentially in a predetermined time interval.

The processor 430 inserts into one or more images (subject images) other images in the image group according to user input and thereby generates a multi-depth image for each of the subject images (S904). The user input may be a first user input or a second user input for inserting another or other images in the subject image, wherein the insertion may be made in the first mode in response to the first user input or the second mode in response to the second user input.

For example, the processor 430 may insert one or more images in the first mode into an image P₄ at a specific position(s). Alternatively, as shown with an image Pₖ, the processor 430 may insert one or more images in the first mode into the image Pₖ and insert another image in the second mode. The processor may also insert into an image in the image group other images in the same image group.

The processor 430 sets, among the images in the image group, images P₄, Pₖ, and Pₘ with other images inserted therein, that is, the subject images as stop positions (S906). In response to a reproduction input (reproduction command) for an image group, the processor 430 sequentially reproduces the images in the image group beginning with image P₀. Upon reaching image P₄ which is set to the stop position, processor 430 stops reproducing at P₄. This allows the user to check other images inserted at the position of a first marker 1010 (‘⊙’) in image P₄.

Upon receiving another user input for reproducing the images in the image group, the processor 430 sequentially reproduces the images beginning with image P₅ and then stops reproducing at Pₖ which is set as the next stop position. The user can then select the first marker 1010 (‘⊙’) or the second marker 1020 in image Pₖ to check images inserted into image Pₖ in the first mode or the second mode. Again, upon receiving yet another user input for reproducing the image group, the processor 430 starts reproducing from image Pₖ₊₁ and then stops reproducing at image Pₘ which is set as the next stop position.

In this way, the images between the first image of the image group and the first stop position, images between the stop positions, and images between the last stop position and the last image of the image group are transition images that are uninterrupted in reproduction.

Meanwhile, the user may remove images inserted into an image corresponding to a stop position in the image group. In this case, the processor 430 cancels the setting of the stop position of the corresponding image. When the user newly inserts images into another image in the image group, the processor 430 sets the other image with the newly inserted images in the image group as a stop position.

One image group with one or more stop positions set therein in this way may be inserted into another image in the first mode or the second mode.

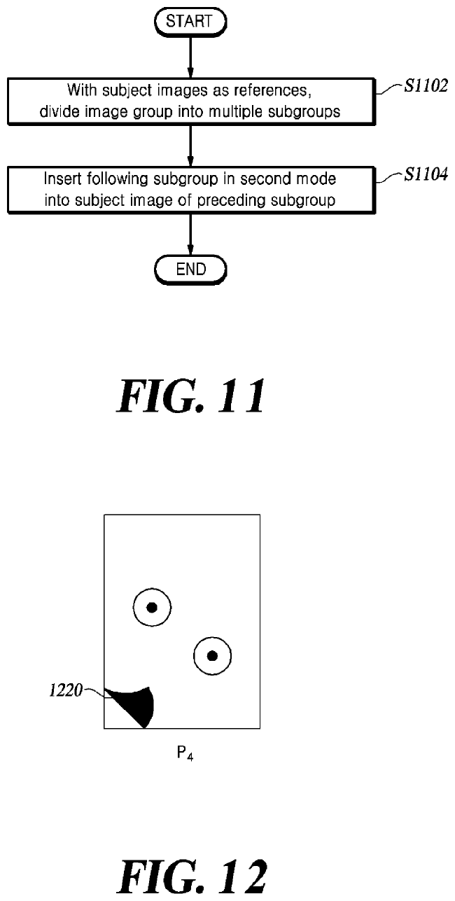

The above application may be implemented in a manner as shown in FIG. 11, by classifying or dividing an image group into a plurality of subgroups with stop positions as references (S1102), and inserting into the last image of a preceding subgroup, the following subgroup in the second mode (S1104).

Referring to the example of FIG. 10, when images P₄, Pₖ, and Pₘ are set to stop positions, the processor 430 sets images P₀ to P₄ as a first subgroup, images P₅ to Pₖ as a second subgroup, images Pₖ₊₁ to Pₘ as a third subgroup, and images Pₘ₊₁ to Pₙ as a fourth subgroup. In this way, a plurality of subgroups is divided from the image group based on the subject images each set as a stop position. The subgroups are each composed of one or more images positioned between two adjacent subject images among subject images and an image that comes later (the last image in the subgroup) in reproduction order among the two adjacent subject images.

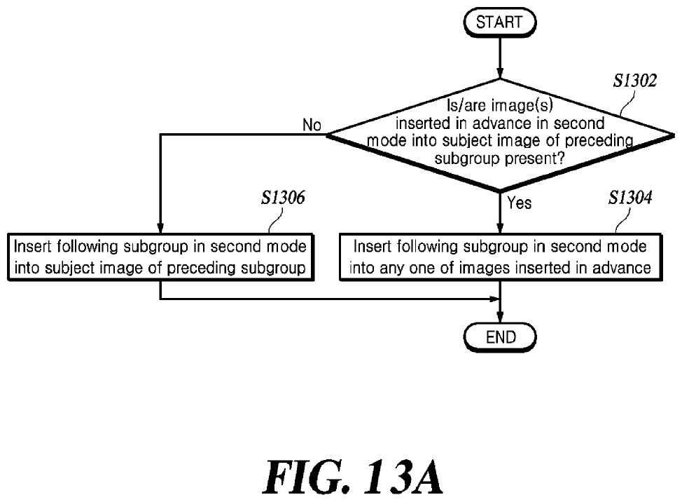

The processor 430 inserts the second subgroup in the second mode into image P₄ which is the last image of the first subgroup and corresponds to the stop position. In this case, as shown in FIG. 12, a second marker 1220 is displayed in image P₄, indicating the presence of image inserted in the second mode. Furthermore, the processor 430 inserts the third subgroup in the second mode into image Pₖ which is the last image of the second subgroup and corresponds to the stop position. Furthermore, the processor 430 inserts the fourth subgroup in the second mode into image Pₘ which is the last image of the third subgroup and corresponds to the stop position.

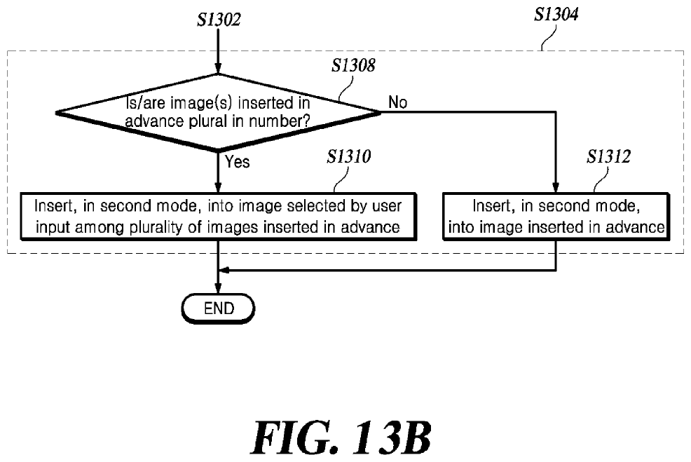

Meanwhile, there may be an image(pre-inserted image) present that has been previously inserted in the second mode into the subject image of the preceding subgroup. In this case, as shown in FIG. 13A, the processor 430 may determine or identify whether or not an image(s) pre-inserted in the second mode into the subject image of the preceding subgroup is/are present (S1302), and if one or more pre-inserted images are present, it may insert the following subgroup in the second mode into any one of pre-inserted images (S1304).

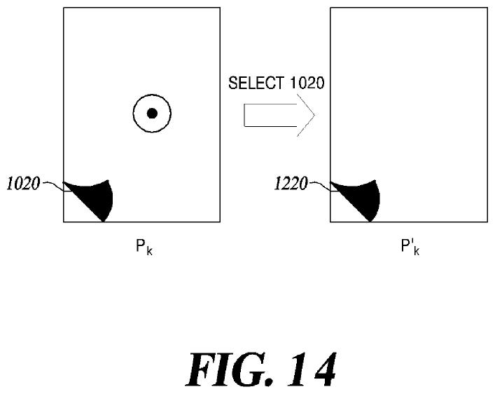

For example, as shown in FIG. 14, image Pₖ has a second marker 1020 displayed therein. This indicates that image Pₖ already has another image Pₖ′ (a pre-inserted image) inserted therein in the second mode. In this case, the third subgroup may be inserted not into image Pₖ but inserted in the second mode into the pre-inserted image Pₖ′ that has been previously inserted in the second mode into image Pₖ. A distinction should be made between this second marker 1020 for the other pre-inserted image Pₖ′ in the image Pₖ and the second marker 1220 for the third subgroup.

If no pre-inserted image is present, the processor 430 inserts the following subgroup in the second mode into the subject image of the preceding subgroup as described above (S1306).

Meanwhile, the pre-inserted image(s) may be plural in number. In the case that there is a plurality of pre-inserted images, the processor 430 may insert in the second mode the following subgroup into any one image selected by the user among the pre-inserted images, as shown in FIG. 13B (S1308 to S1312). In particular, the processor 430 determines whether there is a plurality of pre-inserted images (S1308) and if so, it inserts, in the second mode, the following subgroup into the image selected by the user input (pre-inserted image) (S1310). If there is only one pre-inserted image, the processor 430 inserts, in the second mode, the following subgroup into that one pre-inserted image (S1312).

Upon receiving a reproduction input from the user, the processor 430 sequentially reproduces the images in the first subgroup and stops reproduction at image P₄. Since image P₄ has the second subgroup inserted therein in the second mode, image P₄ has the second marker 1220 displayed therein. When the user selects the second marker 1220, the processor 430 sequentially reproduces images of the second subgroup inserted in image P₄ and stops reproduction at image Pₖ. When the user selects the second marker 1220 corresponding to the third subgroup inserted into image Pₖ or inserted into image Pₖ′ which is pre-inserted in image Pₖ, the images of the third subgroup are sequentially reproduced.

Meanwhile, the stop position may be set by inserting an ‘image present in the image group’ into the subject image, or the stop position may be set by inserting an ‘image not present in the image group’ into the subject image. In other words, another image to be inserted for setting the stop position may be present or not in the image group.

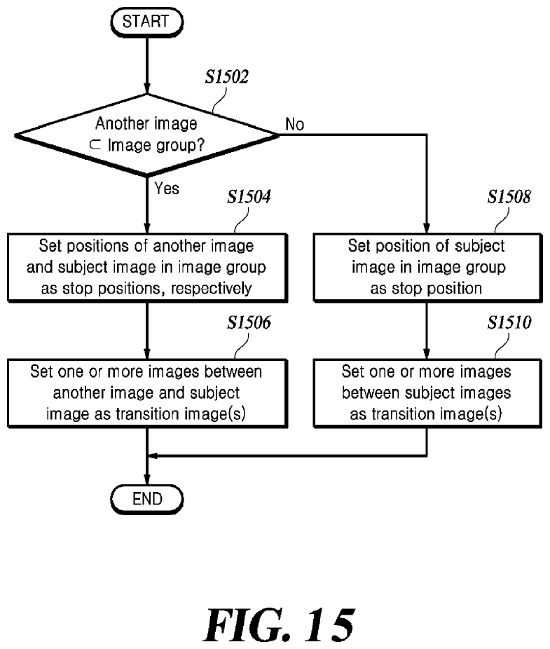

To this end, as shown in FIG. 15, upon receiving the first user input or the second user input, the processor 430 determines whether another image, i.e., a to-be-inserted image belongs to the image group (S1502). If the to-be-inserted image belongs to the image group, the processor 430 sets the position of the to-be-inserted image in the image group and the position of the subject image with the to-be-inserted image inserted therein in the image group as stop positions, respectively (S1504). Additionally, the processor 430 sets one or more images in the image group which are present between the to-be-inserted image and the subject image, as a transition image(s) (S1506).

Referring to the example of FIG. 10, when a second image (e.g., P₄) in the image group is inserted in the first mode or the second mode into a first image (e.g., P₀) in the image group, the first image P₀ and the second image P₄ are each set as stop positions. Images P₁ to P₃ between the first image P₀ and the second image P₄ are set as transition images. Accordingly, when user input is received for selecting a first marker (in case of insertion in the first mode) or a second marker (in case of insertion in the second mode) corresponding to the second image P₄ inserted into the first image P₀, images are sequentially reproduced beginning with image P₁ to image P₄. This means that images P₁ to P₃ become transition images to be outputted during the transition from the first image P₀ to the second image P₄. Accordingly, when the user selects a marker displayed in image P₀, the processor 430 sequentially reproduces images P₁ to P₃ and lastly reproduces image P₄

As another example, among the images shown in FIG. 10, the last image Pₙ may be inserted into the first image P₀ in the first mode or the second mode. In this case, images P₁ to Pₙ₋₁ become transition images. Accordingly, when the user selects a marker displayed in image P₀, the processor 430 sequentially reproduces images P₁ to Pₙ₋₁ and finally reproduces image Pₙ. In other words, images P₁ to Pₙ are sequentially reproduced without stopping.

If the to-be-inserted image does not belong to the image group, the processor 430 sets only the position of the subject image in the image group as the stop position (S1508). Additionally, the processor 430 sets one or more images in the image group that are present between the subject images, that is, between the subject image of the preceding subgroup and the subject image of the following subgroup, as a transition image(s) (S1510).

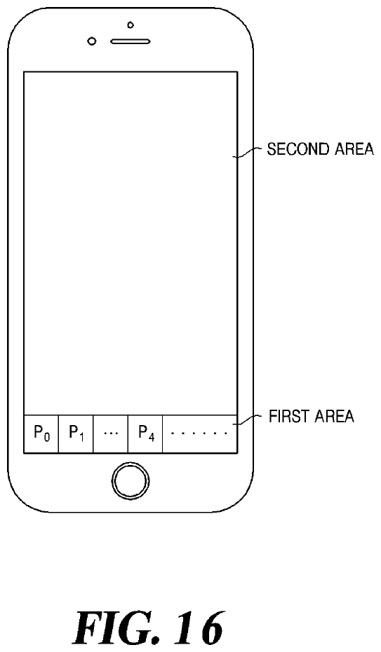

FIG. 16 is an exemplary diagram illustrating a user interface for implementing an extended application of the present disclosure.

The processor 430 displays on the display unit 440 a first area and a second area separated from each other. The first area may display images in an image group in a reproduction sequence or in random order. The reproduction sequence may be changed by changing the positions of the images displayed in the first area.

When an image in which another image is to be inserted is selected from among the images displayed in the first area, the selected image is displayed in the second area. When another pre-stored image is inserted in the first mode or the second mode into the image displayed in the second area, the image displayed in the second area is set as a stop position. Meanwhile, an image displayed in the first area may be inserted into the image displayed in the second area. In this case, the inserted image in the first area may be removed from the image group.

Although the steps in FIGS. 5, 9, 11, 13, and 15 are described to be sequentially performed, they merely instantiate the technical idea of some embodiments of the present disclosure. Therefore, a person having ordinary skill in the pertinent art could appreciate that various modifications, additions, and substitutions are possible by changing the sequences described in the respective drawings or by performing two or more of the steps in FIGS. 5, 9, 11, 13, and 15 in parallel, without departing from the gist and the nature of the embodiments of the present disclosure, and hence the steps in FIGS. 5, 9, 11, 13, and 15 are not limited to the illustrated chronological sequences.

The steps as illustrated in FIGS. 5, 9, 11, 13, and 15 can be implemented as computer-readable codes on a computer-readable recording medium. The computer-readable recording medium includes any type of recording device on which data that can be read by a computer system are recordable. Examples of the computer-readable recording medium include non-transitory mediums such as a ROM, a RAM, a CD-ROM, magnetic tape, a floppy disk, and optical data storage and transitory medium such as a carrier wave (e.g., transmission through the Internet) and data transmission medium. Further, the computer-readable recording medium can be distributed in computer systems connected via a network, wherein the computer-readable codes can be stored and executed in a distributed mode.

Although exemplary embodiments of the present disclosure have been described for illustrative purposes, those skilled in the art will appreciate that various modifications and changes are possible, without departing from the idea and scope of the disclosure. Exemplary embodiments have been described for the sake of brevity and clarity. Accordingly, one of ordinary skill would understand that the scope of the present disclosure is not limited by the embodiments explicitly described above but is inclusive of the claims and equivalents thereto.

### CROSS-REFERENCE TO RELATED APPLICATIONS

The present application claims priority to Korean Patent Application No. 10-2020-0066896 filed on Jun. 3, 2020, and Korean Patent Application No. 10-2020-0180958 filed on Dec. 22, 2020, which are incorporated herein by reference in their entirety.

What is claimed is:

1. A method of generating a multi-depth image capable of smooth transition between images, the method comprising:
according to a user input, determining an image group including a plurality of images;
generating multi-depth images for each of one or more subject images included in the image group, according to a user input for inserting at least one other image in each of the one or more subject images; and
setting each of the subject images corresponding to generation of the multi-depth images as stop positions, respectively, at which the images in the image group are stopped from being reproduced during reproduction.

2. The method of claim 1, further comprising:
dividing, with each of the subject images set as stop positions as reference, the image group into a plurality of subgroups each composed of one or more images positioned between two adjacent subject images among the subject images and a subject image that is reproduced later among the two adjacent subject images; and
inserting in a second mode into a subject image of a preceding subgroup a following subgroup among the plurality of subgroups,
wherein in the second mode, one image out of two images is inserted in the other image, based on a node attribute defining a connection relationship between the two images without a coordinate attribute for indicating where in the other image the one image is to be inserted.

3. The method of claim 2, wherein the inserting in the second mode comprises:
identifying whether one or more images pre-inserted in the second mode in the subject image of the preceding subgroup is present; and
in response to the presence of the one or more pre-inserted images, inserting in one of the pre-inserted images the following subgroup in the second mode.

4. The method of claim 3, wherein the following subgroup, in the case that more than one pre-inserted images are present, is inserted into an image selected by user input among the more than one pre-inserted images in the second mode.

5. The method of claim 1, wherein the setting of the subject images as stop positions comprises:
in the case that the at least one other image to be inserted in one subject image of the subject images is an image that belongs to the image group, setting a position of at least one other image in the image group and a position of the one subject image in the image group, as the stop positions.

6. The method of claim 5, wherein the setting of the subject images as stop positions comprises:
further setting one or more images positioned between the at least one other image and the one subject image in the image group as transition images that are not stopped from being reproduced.

7. A computer-readable recording medium storing a computer program for causing a computer to execute the method as claimed in claim 1.
